(19) United States
(12) Patent Application Publication
(10) Pub. No.: US 2017/0308945 A1
(43) Pub. Date: Oct. 26, 2017

(54) FOOTWEAR POINT OF SALE AND MANUFACTURING SYSTEM AND METHOD

(71) Applicant: Wolverine Outdoors, Inc., Rockford, MI (US)

(72) Inventors: Christopher John Loveder, Rockford, MI (US); Robert Arthur Murphy, Cedar Springs, MI (US); Dalton Wesley Strong, Grand Rapids, MI (US); Daniel James VanWagnen, Grand Rapids, MI (US)

(21) Appl. No.: 15/491,373

(22) Filed: Apr. 19, 2017

Related U.S. Application Data
(60) Provisional application No. 62/327,064, filed on Apr. 25, 2016.

(51) Int. Cl. G06Q 30/06; B33Y 50/00; G07F 11/70; B29L 31/50

(52) U.S. Cl. CPC G06Q 30/0621; G07F 11/70; B33Y 50/00; B29L 2031/50

(57) ABSTRACT

System and method for generating a custom last for a consumer, and providing the custom last to at least one of a) a virtual footwear generator and b) a manufacturing processor for producing the custom last and manufacturing footwear based on the custom last. The system and method may also include a virtual store front or point of sale system.

### TECHNICAL FIELD

The present application relates to a system and method for fitting custom footwear to a consumer and manufacturing the custom footwear. More specifically, the present application focuses on a footwear virtual purchasing system and method and an additive based footwear manufacturing system and method.

### BACKGROUND

Conventional brick and mortar storefronts for footwear dedicate a large amount of space to display and stock footwear. Further, the logistical pipeline for such storefronts, including decisions about which shoes are projected to be popular and which sizes of shoes to keep in inventory, can often result in either too much inventory or too little inventory, and possibly no inventory, at the actual store. Conventional efforts have focused on avoiding both of these circumstances; however, despite such efforts, consumers and particularly consumers with uncommon foot sizes often find that popular shoe models are out of stock when visiting a footwear storefront. Likewise, shoe models that are less popular may become stale or remain too long in inventory at the store and take up space that could be utilized for other purposes, and may ultimately be moved for sale at steep discounts. Because predicting whether a particular shoe will become popular is generally considered an art, the storefront owner and the consumer can become frustrated with the traditional brick-and-mortar model of inventory management.

Consumers also tend to become frustrated with traditional brick-and-mortar footwear storefronts due to the limited size configurations or the standard available set of sizes. For instance, a consumer who has extra wide feet and prefers extra room for comfort in the toebox or the medial and lateral sides, may have very few shoe standard options, if any, to choose from in a traditional brick-and-mortar storefront. Further, in most cases, the standard selection of footwear at a traditional brick-and-mortar storefront does not include footwear sized or configured to specifically address consumer foot issues, such as pronation and supination. Because there are a large number of foot issues specific to individual consumers, stores often do not keep inventory of footwear for all types of foot issues. Doing so is not considered economically sound in the footwear industry. If a consumer has such an issue, he is likely to be referred to a specialist. This process not only delays delivery and adds to the total cost of the footwear, but also limits the available selection of footwear models to choose from in many cases.

### SUMMARY OF THE DESCRIPTION

The present disclosure is directed to a system and method for generating a custom last for a consumer, and providing the custom last to at least one of a) a virtual footwear generator and b) a manufacturing processor for producing the custom last and manufacturing footwear based on the custom last. The system and method may also include a virtual store front or point of sale system.

In one embodiment, there is a method of manufacturing a custom last for a consumer. The method may include obtaining, via a sensor, physical characteristic data with respect to a foot of the consumer, and determining a standard last for the foot based on the physical characteristic data. The method may also include obtaining from memory standard characteristic data for a standard foot that is the basis for the standard last, and comparing the standard characteristic data for the standard foot against the physical characteristic data for the foot of the consumer. Based on the comparison, the standard last may be modified to yield a customized last for the foot of the consumer. The customized last may be three-dimensionally printed to facilitate manufacture of footwear customized for the consumer and based on the customized last.

In another embodiment, the method may include obtaining, via a user interface, consumer preference data, such as an application type (e.g., hiking or running) and a preferred fit (e.g., tight or loose fits). Based on the consumer preference data, the standard last may be modified or the customized last may be further modified. For example, the consumer preference data may be utilized to determine further differences between the standard foot and the consumer's foot, and these differences along with differences noted in the comparison between the standard foot and the consumer's foot may form the basis for modification to the standard last.

In yet another embodiment, the method may include generating a virtual footwear model based on a modified virtual last that is customized to the consumer's foot. The virtual footwear model may be communicated to a display interface that forms part of a virtual storefront or point of sale system. The consumer may visualize the virtual footwear model and choose to purchase footwear based on the virtual footwear model. In response to a purchase, an encoded document may be generated that includes descriptive fields for producing a real-life form of the modified virtual last and manufacturing footwear using the real-life form of the modified virtual last.

In still another embodiment, a system for producing custom footwear may include a consumer interface configured to display a plurality of footwear models available for selection by a consumer, and a sensor configured to scan foot characteristics of the consumer to collect physical characteristic data relating to the foot. The system may include a control system operably coupled to the consumer interface and the foot sensor, and programmed to receive the physical characteristic data from the sensor. The control system may also be programmed to receive, from the consumer, preference data and a consumer footwear selection relating to a consumer-desired footwear from among the plurality of footwear models displayed on the consumer interface. The control system may generate a custom virtual last for the consumer's foot based on the physical characteristic data and the consumer preference data, and generate a virtual footwear model based on the custom virtual last.

The system may include a manufacturing system for assembling the footwear model. The manufacturing system may produce a real-life form of the custom virtual last, and utilize the real-life form as a basis for assembling the footwear model. As an example, the real-life form may be generated by additive manufacturing techniques in a relatively short amount of time.

These and other advantages and features of the invention will be more fully understood and appreciated by reference to the description of the current embodiment and the drawings.

Before the embodiments of the invention are explained in detail, it is to be understood that the invention is not limited to the details of operation or to the details of construction and the arrangement of the components set forth in the following description or illustrated in the drawings. The invention may be implemented in various other embodiments and of being practiced or being carried out in alternative ways not expressly disclosed herein. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof. Further, enumeration may be used in the description of various embodiments. Unless otherwise expressly stated, the use of enumeration should not be construed as limiting the invention to any specific order or number of components. Nor should the use of enumeration be construed as excluding from the scope of the invention any additional steps or components that might be combined with or into the enumerated steps or components.

### BRIEF DESCRIPTION OF THE DRAWINGS

FIG. 1 shows a representative view of a system for producing a custom last and custom footwear based on the custom last according to one embodiment;

FIG. 2 shows a method of producing a custom last and custom footwear according to one embodiment;

FIG. 3 depicts a standard model last according to one embodiment;

FIG. 4 depicts a custom, modified version of the standard model last according to one embodiment;

FIG. 5 depicts the custom, modified last of FIG. 4 with component locations of footwear mapped onto the last;

FIG. 6 shows a custom, modified version of the standard model last of FIG. 3 with modifications for boot wear;

FIG. 7 depicts a custom, modified last according to one embodiment showing mesh lines along with component locations of footwear mapped onto the mesh lines;

FIG. 8 shows a side-by-side comparison of a virtual representation of footwear based on a custom modified last next to a real-life counterpart manufactured based on a custom, modified last and the virtual representation;

FIG. 9 depicts optional color selection capabilities provided by a visual storefront according to one embodiment;

FIG. 10 shows a virtual storefront according to one embodiment;

FIG. 11 depicts a representative view of a method for mapping footwear components on a modified virtual last to facilitate generation of custom footwear according to one embodiment; and

FIG. 12 shows a standard footwear component ready for assembly in conjunction with a modified last according to one embodiment.

### DESCRIPTION

A system and method in accordance with one embodiment includes a method of generating a custom last for a consumer, and providing the custom last to at least one of a) a virtual footwear generator and b) a manufacturing processor for producing a real-life form of the custom last and manufacturing footwear based on the real-life form.

The system and method may include comparing a) model last information with respect to a standard last against b) one or more physical aspects of a consumer's foot, and generating a virtual form of the custom last based on the comparison. For instance, the model information may include one or more physical aspects of a standard foot from which the standard last has been generated. The comparison may include comparing the one or more physical aspects of the standard foot to the one or more physical aspects of the consumer's foot, and modifying the standard last based on deviations identified in the comparison. These modifications to the standard last may yield a custom generated last. The custom generated last may be used as a basis for generating a virtual footwear model for a virtual point-of-sale interface and display to a consumer. The custom generated last may be used as a basis for manufacturing the virtual footwear model in response to consumer selection of the same.

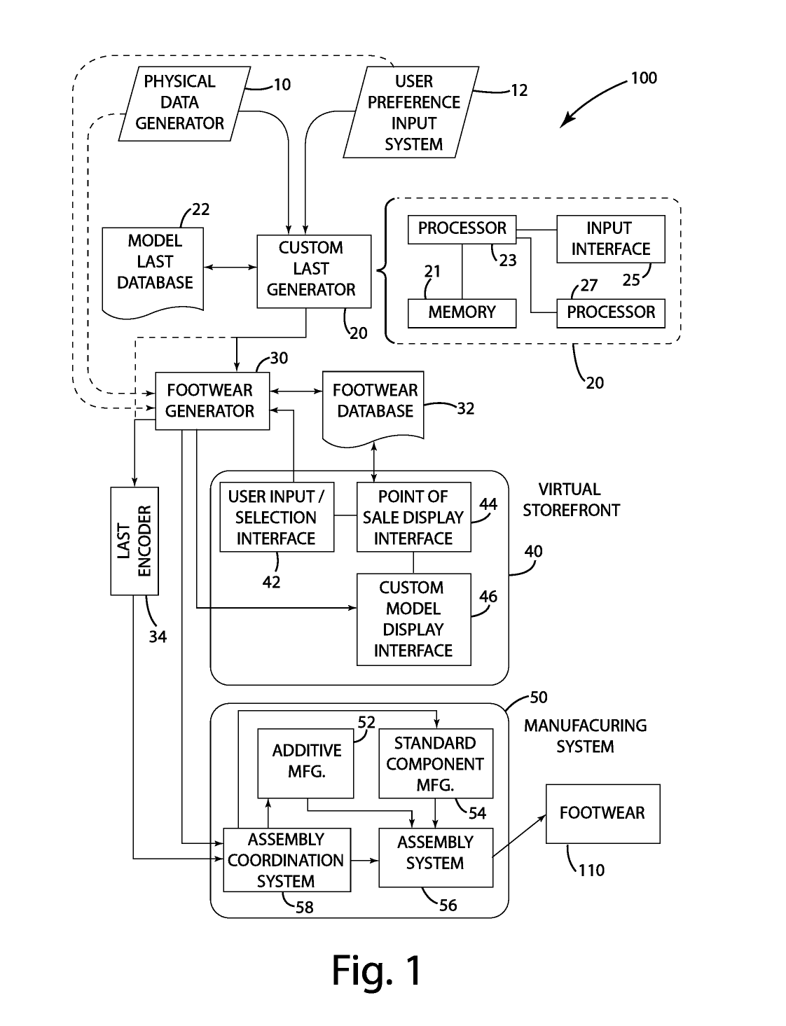

A system of generating a custom last, providing a virtual storefront or point-of-sale interface, and manufacturing footwear with the custom last is shown in FIG. 1 and generally designated 100. For purposes of disclosure, the system 100 in the illustrated embodiment of FIG. 1 is depicted with several components, including a custom last generator, a virtual storefront and a manufacturing system. It should be understood that the system 100 may include all or a subset of the components depicted in the illustrated embodiment. It should further be understood that the system 100 may include any combination of the one or more components described in the illustrated embodiment along with any of the one or more components described herein.

### I. Custom Last Generator

The system 100 may include a custom last generator 20 operably coupled to a physical data generator 10 and a user preference input system 12. The custom last generator 20 may be communicatively coupled to a last database 22. An example configuration of the custom last generator 20 is also depicted in the illustrated embodiment to highlight that the custom last generator 20 may include one or more of the following: a processor 23, memory 21, an input interface 25, and an output interface 27. The input interface 25 may include one or more input communication interfaces, including, for example, wired communication and wireless communication capabilities Likewise, the output interface 27 may include one or more output communication interfaces, including at least one wired interface and at least one wireless interface, or any combination thereof. The processor 23 and memory 21 may be configured to generate a custom last according to one or more processes described herein.

For instance, the processor 23 and memory 21 may be programmed to receive, via the input interface 25, physical characteristic information with respect to a consumer's foot. Additionally, or alternatively, the processor 23 and memory 21 may be programmed to receive user preference information via the input interface 25. The custom last generator 20 may communicate with a model last database 22 to obtain model information with respect to a standard last 102 (e.g., a standard size 6 last). Based on at least one of the physical characteristic information and the user preference information, and based on the model information about the standard last 102, the processor 23 of the custom last generator 20 may modify the standard last to yield a modified last 150.

For purposes of disclosure, the model last database 22 is depicted as a component separate from the custom last generator 20. For instance, the model last database 22 may be provided by a server component that is communicatively coupled to the custom last generator 20 via a network interface of the input and output interfaces 25, 27. The custom last generator 20 may query the model last database 22 for model information relating to a particular type of standard last.

The model last database 22 may serve a plurality of custom last generators 20 respectively disposed at a plurality of point-of-sale locations. The model last database 22 may be updated from time to time such that changes to model information in the model last database 22 may be utilized by each of the plurality of custom last generators 20. The present disclosure is not limited to a model last database 22 available via a network interface—for instance, the model last database 22 may be integrated into the custom last generator 20 such that model information for a plurality of standard lasts may be stored in the memory 21.

The user preference input system 12 may provide an interface through which a consumer can provide preference data with respect to footwear. In one embodiment, the user preference input system 12 may be incorporated into a point-of-sale system, such as a kiosk or the virtual storefront 40, that facilitates browsing and selection of footwear for purchase. The user preference data may relate to or pertain to various information with respect to the consumer and/or the consumer's purpose for making a footwear purchase. For instance, the consumer may be looking to purchase footwear for a specific application, such as walking, work, a formal event, hiking, soccer, football, baseball, basketball and tennis. The user preference input system 12 may be configured to obtain this information, and may be further configured to inquire with the user about particular aspects of the application, such as terrain for hiking, type of court for tennis (e.g., clay or hardcourt) and playing field conditions (e.g., turf or grass). The user preference input system 12 may also be configured to obtain information relating to desired fit, such as a looser or tighter fit for instep girth and/or a looser or tighter fit for foot ball girth. Additional examples of desired fit information include a looser or tighter fit near medial and lateral sides of the foot, more or less room in the toebox, and a narrower or wider angle opening.

The custom last generator 20 may use the user preference data as a basis for modifying a standard last 102 to yield a custom last 150 according to one embodiment discussed herein.

The physical data generator 10 may be disposed in proximity to the user preference input system 12, or may be implemented at least in part by the same components as the user preference input system 12. In one embodiment, the physical data generator 10 may form part of a point-of-sale system that incorporates the user preference input system 12 as well as the virtual storefront 40. Such a point-of-sale system may be a kiosk from which consumers can purchase footwear. Additionally, or alternatively, the point-of-sale system, including the physical data generator 10 and the user preference input system 12, may be incorporated into a mobile device such as a smart phone or tablet. The mobile device may be configured to provide a virtual storefront 40 according to one embodiment described herein.

The physical data generator 10 may obtain physical information relating to one or more physical aspects of the consumer. As described herein, the principal difference between a physical aspect and a user preference is that the physical aspect is objective (e.g., it can be physically measured using one or more sensors or instruments) and the user preference is subjective. For instance, the consumer's weight and height are physical aspects that can be objectively measured with sensors. It should be understood, however, that the physical data generator 10 may not utilize a sensor to obtain one or more physical aspects, and that manual entry of one or more physical aspect is permissible in one embodiment based on a manual measurement.

Examples of the physical information obtainable by the physical data generator 10 include a three-dimensional scan of the entire foot shape. Accuracy with respect to such a three-dimensional scan according to one embodiment may be enhanced through use of an active scanning system that utilizes an infrared source and camera to identify the physical shape of a consumer's foot with 1:1 scaling within a given degree of tolerance. One type of scanning system that may be used in conjunction with the physical data generator 10 is the Easy 3D Scanning software sold by Cappasity that utilizes a camera (e.g., a DSLR camera) to scan an object to provide a 3D model of the object with a tolerance of 2 mm with respect to the surface of the object. Additional examples of physical information include focused measurements for one or more of the following: foot length, width, arch height, arch location, foot shape, footprint, shoe size, flexion or extension of foot in various directions, inversion or eversion of the foot, strength of various foot muscles, bone alignment, pronation, and supination, one or more for contours, and a foot pressure profile or force generated by the foot, or any other foot related characteristic.

As mentioned above, one or more physical characteristics of the consumer's foot may be measured with one or more sensors, such as an active scanning system. The one or more sensors may include a pressure plate on which the consumer may stand to obtain a foot pressure profile or measurements with respect to forces generated by the foot. Additional examples of sensors for measuring one or more physical aspects include a low-pressure sensing mat configured to capture static and dynamic pressure measurement data for at least one of foot function, gait analysis, balance, sway, and postural data. An example configuration of such a mat can be obtained from Tekscan under the product name MatScan.

The custom last generator 20 may receive the physical information from the physical data generator 10, and use this information as a basis for generating a custom last 150. In the illustrated embodiment, the custom last generator 20 may determine a stick length (e.g., size 6, 7, 8, etc.) of the consumer's foot based on the physical information. It is noted that the stick length standard may vary from region to region (e.g., U.S. sizing vs. European sizing). The custom last generator 20 may query the model last database 22 for model information relating to a standard last 102 that corresponds to the measured stick length. It should be understood that the present disclosure is not limited to obtaining model information with respect to a standard last 102 based on stick length, and that selection of the standard last 102 may be based on one or more additional or alterative physical characteristics of the consumer's foot. For instance, the standard last 102 may be chosen based on stick length and foot width.

It should be noted that the standard last 102 and related model information for a given stick length may not be the same for all footwear manufacturers. For instance, the standard size 6 last and related model information used by a manufacturer may have been developed based on running applications, and therefore the last may have a generally tight toebox to substantially avoid slippage. Another manufacturer, on the other hand, may have developed its standard lasts for use with military applications that use a comparatively looser toebox. The model last database 22 may include information with respect to standard lasts for one or more manufacturers, and may be configured to provide model information with respect to a standard last for a given manufacturer.

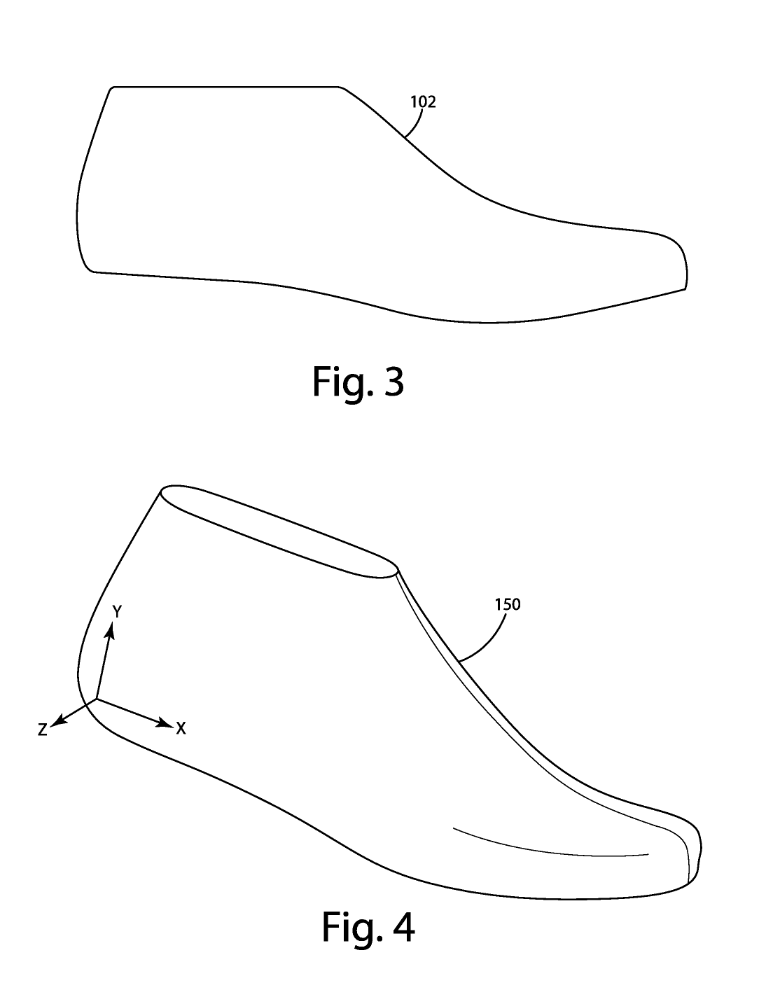

The model information provided by the model last database 22 may include data relating to the physical dimensions of the standard last queried by the processor 23 of the custom last generator 20. The illustrated embodiment of FIG. 3 depicts a standard size 6 model last 102 for one footwear manufacturer. The model information may also include standard foot information (e.g., one or more physical dimensions) of the standard foot used as a basis for the standard model last 102. For instance, the model information may include a three-dimensional model of the standard foot with 1:1 scaling. As another example, the standard foot information may include particular dimensions of the standard foot for the standard model last 102, including, for example, the instep girth, the foot ball girth, foot width, arch height, and arch location, or any other foot related characteristic, or any combination thereof.

The custom last generator 20 may conduct a comparison between a) the standard foot information provided by the model last database 22 and b) the physical information obtained from the physical data generator 10. Based on this comparison, the custom last generator 20 may modify the standard model last 102. More specifically, deviations identified in the comparison may be used as a basis for adjusting the standard model last 102 to more closely align with the consumer's foot. For instance, if the physical information with respect to the consumer's foot indicates the arch location of the consumer is closer to the toes than the heel as compared to the arch location of the standard foot, the custom last generator 20 may modify the standard model last 102 accordingly. As another example, if the arch height of the consumer's foot is taller than the arch height of the standard foot by 5%, the custom last generator 20 may modify the standard model last 102 to increase the arch height by 5%. Examples of modified or custom lasts 150 based the standard model last depicted in FIG. 3 are shown in the illustrated embodiments of FIGS. 4-7.

In one embodiment, the degree of deviation between the consumer's foot and the standard foot may be directly translated to a change in the standard model. For instance, a 5% difference between the consumer's foot and the standard foot with respect to one or more physical characteristics may be translated to a 5% modification of the standard model last 102 with respect to one or more respective dimensions of the standard model last that are associated with the one or more deviating physical characteristics. In the illustrated embodiment of FIG. 6, which depicts a modified last 150 according to one embodiment, an example of further modification to a last is shown with respect to dimension D associated with the dorsal surface of the consumer's foot and the standard foot. In this example, it is determined that, in proximity to dimension D, the dorsal surface of the consumer's foot deviates from the standard foot by an amount corresponding to dimension D. Based on this determined deviation from the standard foot, the standard model last 102 (based on the standard foot) may be modified in a corresponding manner as shown. Surfaces of the custom last 150 in proximity to dimension D may be adjusted to create a smooth transition to surrounding areas, as depicted in the illustrated embodiment of FIG. 6. The smoothing function may utilize one or more points of reference, such as vertices 154 in the illustrated embodiment, to use as a basis for smoothing the surfaces surrounding a deviation or modification to the standard last 102. Any type of smoothing function may be utilized, including, for example, the smoothing functions utilized in various image processing and modeling software packages. One such package is the Romans CAD Software package. In one embodiment, a full three-dimensional scan of the consumer's foot may be compared against the standard foot, and a comparison may be conducted to generate a complete three-dimensional map of deviations therebetween. This three-dimensional map may be used as a basis for modifying the surface of the standard model last 102 to yield a modified last 150 customized to a consumer's foot.

In one embodiment, based on a determined stick length of a consumer's foot, the custom last generator 20 may query the model last database 22 for standard foot information separate from a query for a standard model last 102. The custom last generator 20 may determine deviations between the standard foot and the consumer's foot, as discussed herein. The custom last generator 20 may store this deviation information in memory, and obtain a standard model last associated with a type of footwear of interest to the consumer. The standard model last 102 may be modified based on the deviation information. It is noted that, because the deviation information is identified with respect to a standard foot, any type of standard model last based on the standard foot may be modified based on the deviation information. Physical characteristic information about the consumer's foot may be obtained once to determine the deviation information with respect to a standard foot, and multiple custom lasts may be generated based on the deviation information. For instance, a standard last specific to a high heel shoe may be modified based on the deviation information, and another standard last specific to a hiking shoe also may be modified based on the deviation information. In this way, the deviation information between a consumer's foot and a standard foot of similar size may form the basis for a variety of modified lasts 150. In one embodiment, as depicted in FIG. 6, a standard last 102 may be modified for a given application, such as extending the height of a standard last for a shoe in order to facilitate generation of a boot.

The custom last generator 20 may provide custom last information to variety of components in a variety of ways. In one embodiment, the custom last generator 20 may communicate the custom last information to a last encoder 34 that translates the custom last information into an encoded document or file (e.g., an Extensible Markup Language (XML) File) that can be provided to a manufacturer. As an example, the last encoder 34 may provide a digital object model with an encoded document or a mesh file that defines the three-dimensional shape of the custom last 150. The mesh file may include a polygonal mesh in a file format supported by a 3D printer, including for example the STL (stereolithography) file format. The polygonal mesh includes vertices, edges, faces, polygons and surfaces that together form the digital representation of a given custom last 150. The mesh file can optionally include sub-parts, for example sub-parts corresponding to different sub-components of the custom last 150. For purposes of disclosure, the last encoder 34 is described separately from the custom last generator 20—however, the present disclosure is not so limited. The last encoder 34 may be incorporated into any component herein, including, for example, the custom last generator 20 or the footwear generator 30, or both.

### II. Footwear Generator

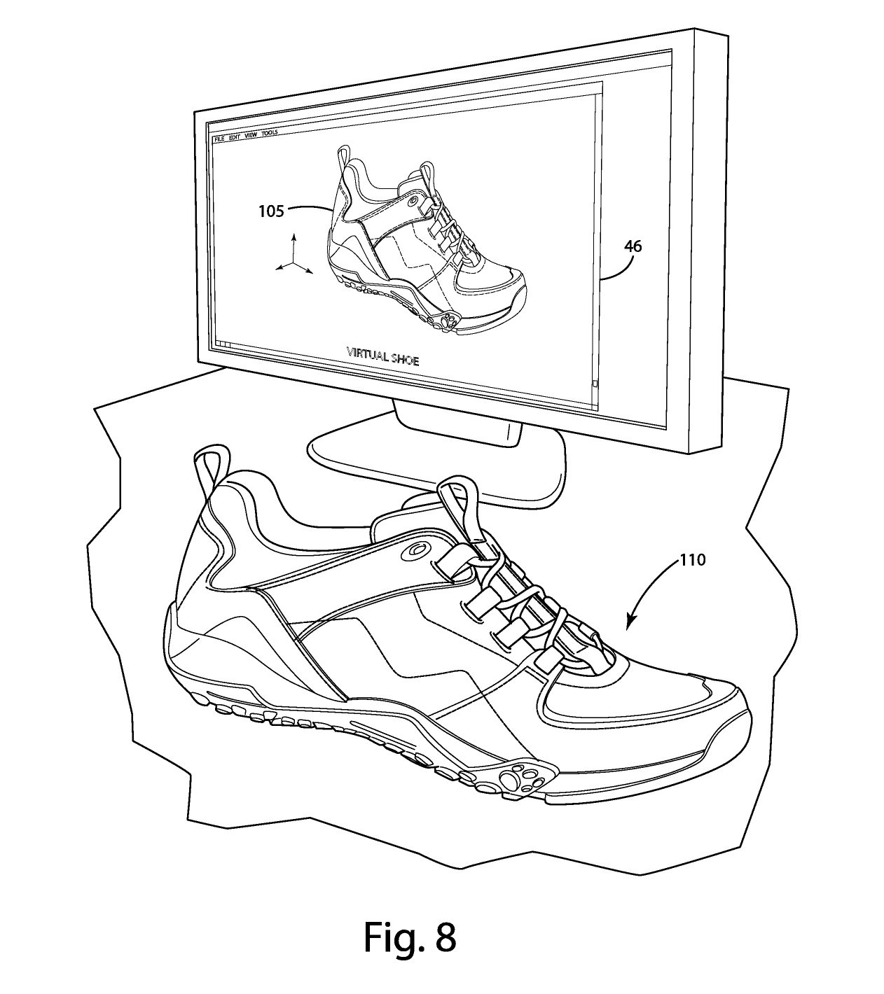

The system 100 may include a footwear generator 30 operably coupled to the custom last generator 20. The footwear generator 30 may include components similar to those of the custom last generator 20, and may include, for example, a processor, memory, an input interface and an output interface. For purposes of disclosure, the footwear generator 30 is depicted separate from the custom last generator 20. Alternatively, the footwear generator 30 and custom last generator 20 may share the same components, including processor 23, memory 21, input interface 25, and output interface 27. The footwear generator 30 may be configured to generate a virtual representation of footwear based on a consumer's footwear selection and the custom last information provided by the custom last generator 20. The virtual representation may be provided to the virtual storefront 40 for display to and possible purchase by the consumer. An example of such a virtual representation is depicted in the illustrated embodiment of FIG. 8 and designated 105.

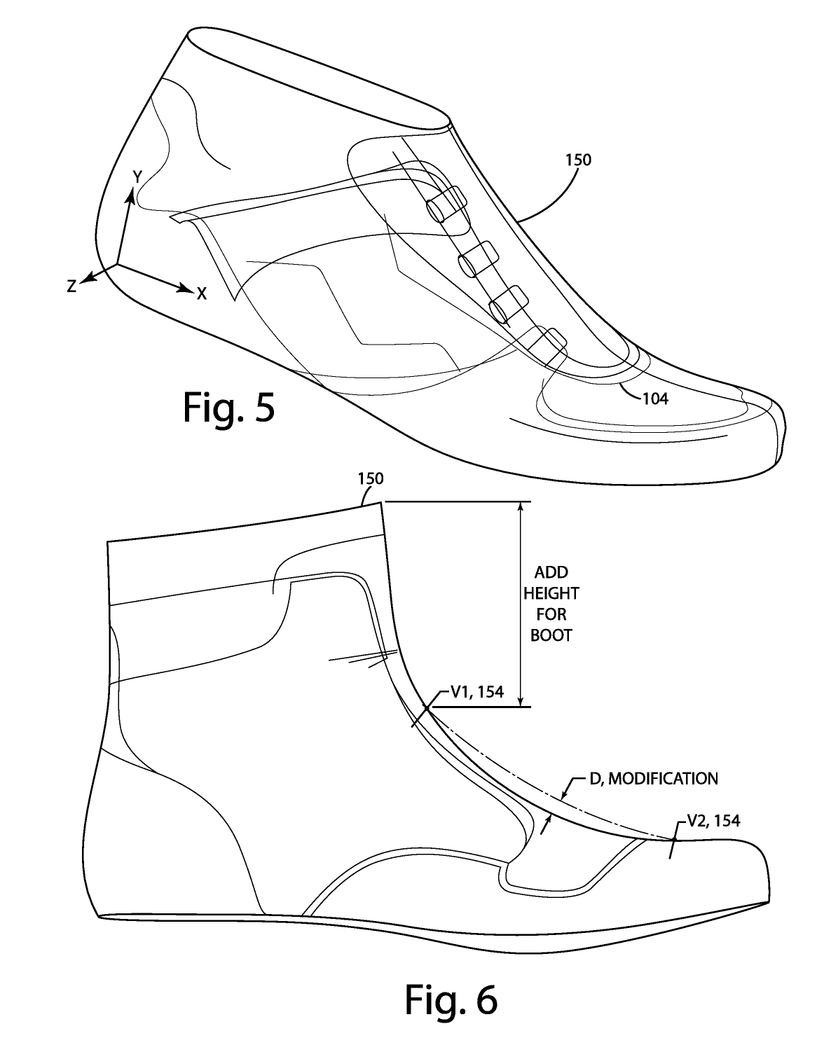

The footwear generator 30 may be operably coupled to a footwear database 32, which optionally may be stored in memory of the footwear generator 30. The footwear database 32, like the model last database 22 may be provided by a server component that is communicatively coupled to the footwear generator 30 via a network interface of the input/output interfaces. The footwear database 32 may include footwear model information relating to construction of footwear with respect to a standard model last retrievable from the model last database 22. This information may take the form of component mappings to the standard model last similar to the component mappings depicted in the illustrated embodiment of FIG. 5. In one embodiment, the footwear model information may include location, layer, and thickness information with respect to individual components for footwear with respect to a standard model last 102. This footwear model information may facilitate rendering of a virtual representation of the footwear based on the standard model last 102, including footwear based on a custom last 150 that itself is based on the standard model last 102. More specifically, in one embodiment, the footwear model information may be scaled based on changes from the standard last 102 to the custom last 150 in order to render the footwear on the custom last 150.

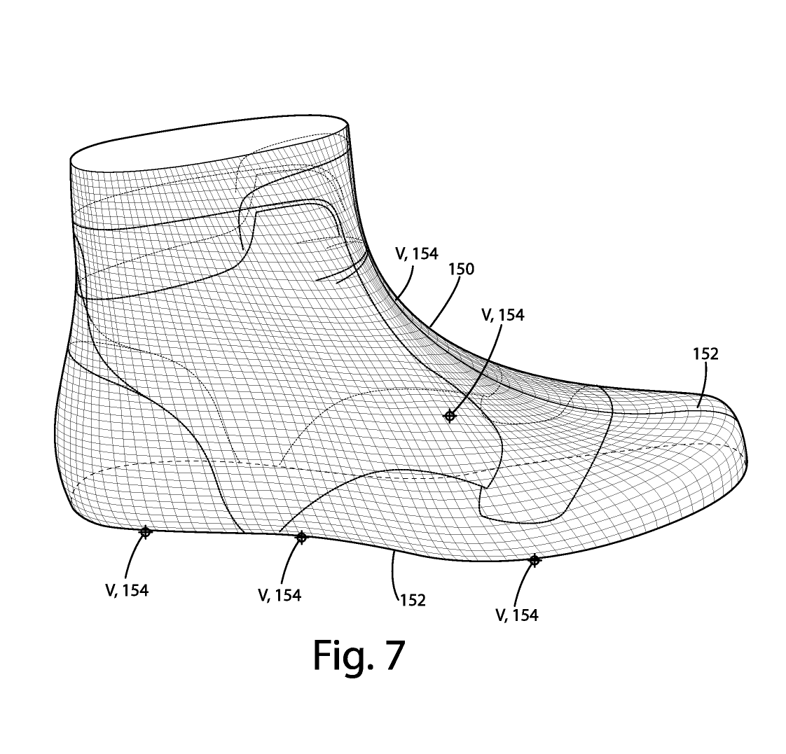

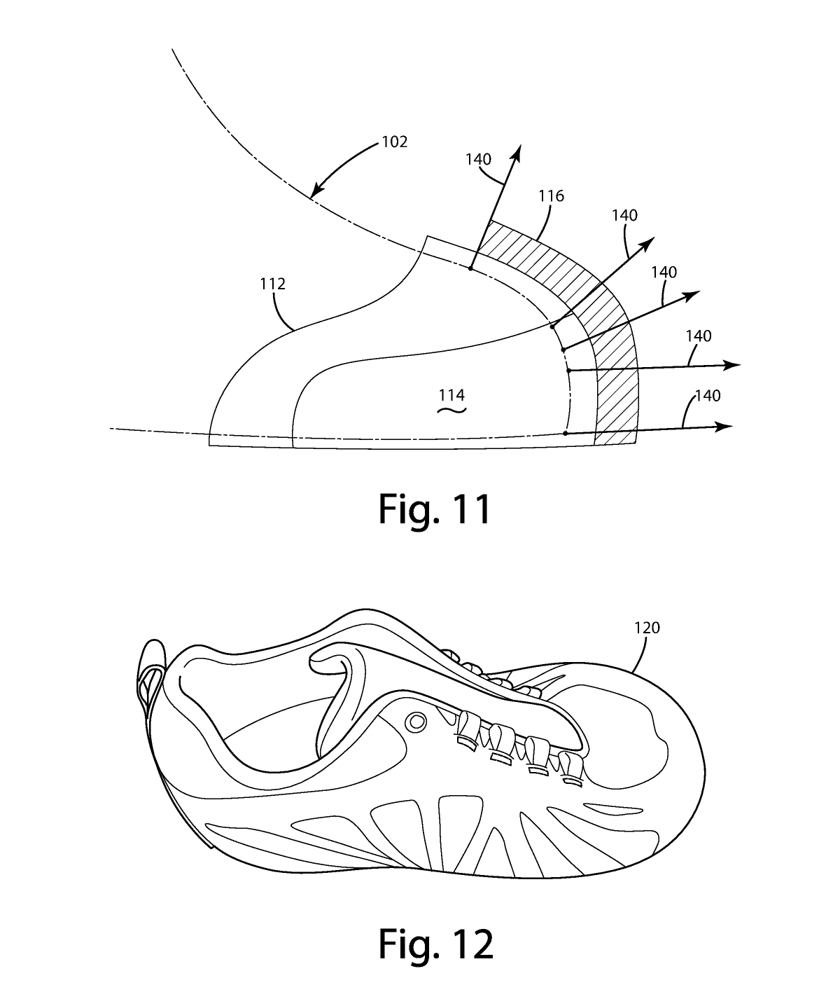

The footwear model information (e.g., location, layer and thickness information) of footwear components relative to a standard last 102 may facilitate generation of the footwear in a manner similar to that depicted in the illustrated embodiment of FIG. 11. The illustrated embodiment depicts three footwear components 112, 114 and 116 from among several footwear components of footwear to be rendered. Additional footwear components are not shown to facilitate understanding of footwear generation based on footwear model information according to one embodiment. The standard last 102 and the custom last 150, as depicted in the illustrated embodiment of FIG. 7, may be digitally represented by a mesh including a plurality of mesh lines 152. The standard last 102 and the custom last 150 may also be digitally represented by a plurality of vertices V, 154 potentially associated with one or more landmarks of the foot.

The footwear model information may identify corresponding location information for each footwear component 112, 114, 116 relative to mesh lines of the standard last 102. In this way, if the standard last 102 is modified, such as by generating the custom last 150 with the custom last generator 20, the location information remains relevant to the construction of the footwear. In other words, by identifying a location of a component relative to the mesh lines of the standard last 102, proportional changes to the mesh lines that result from modifying the standard last 102 may translate directly to a proportional change in the location of the footwear component 112, 114, 116. The ultimate size and shape of the footwear component 112, 114, 116 may vary in this translation process, but the location of the footwear component 112, 114, 116 relative to other components may be consistent such that the components can be joined together to form the footwear about the custom last 150 despite modifications to the standard last 102. Modifications to the surfaces of the standard last 102 may therefore be scaled or mapped to generation of the footwear, including footwear components, from footwear model information with respect to a standard last.

In the illustrated embodiment of FIG. 11, a plurality of rays 140 normal or perpendicular to the surface of the standard last 102 may facilitate scaling the footwear components 112, 114, 116 for different layers of the footwear. As mentioned above, the footwear model information may include layer information as well as location information with respect to footwear components 112, 114, 116. As the footwear is constructed, some layers may be disposed farther away from the surface of the standard last 102 than others. Footwear component 116 is such a component in the illustrated embodiment. In this case, the size of the footwear component 116 is actually larger than it would be if mapped directly to the surface of the standard last 102. The rays 140 facilitate understanding that the component 116 can be scaled depending on its layer location, and its location relative to the mesh lines of the standard last 102 or custom last 150. In other words, the location information for each footwear component may correspond to a mesh location on the surface of the standard last 102, and with the layer information, the size and overall shape of the footwear component can be translated to a virtual representation of the footwear as fitted to the custom last 150 (such as the custom generated last in the illustrated embodiment of FIG. 7.)

Optionally, the footwear generator 30 may also facilitate customization of footwear according to at least one of a) the physical information obtained from the physical data generator 10 and b) the user preference information obtained from the user preference input system 12. Customization options with respect to the footwear can be provided to a manufacturing system in the form of customization information.

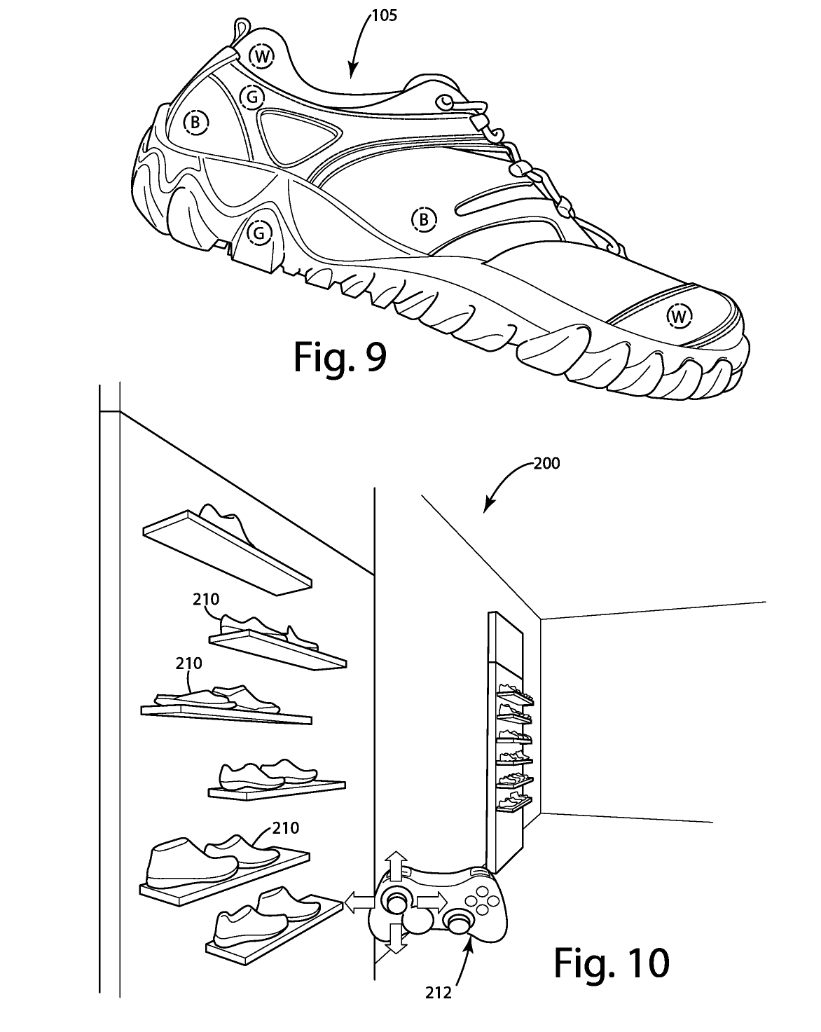

A variety of footwear features can be customized according to one embodiment of the present disclosure. For instance, as depicted in the illustrated embodiment of FIG. 9, different colors may be selected for various components of the footwear. The footwear generator 30 may update the virtual footwear model 105 in real-time based on the color selection, which are designed as white (W), green (G), and blue (B) in the illustrated embodiment of FIG. 9.

As another example, the footwear generator 30 may generate a customized component (e.g., a sole, a midsole, or an insole, or a combination thereof), based on one or more factors, including the physical information and/or the user preference information. Force data or pressure profile data with respect to the consumer's foot, obtained from the physical data generator 10, may facilitate generation of the customized component to more evenly distribute force applied by the consumer's foot and/or enhance comfort. In one embodiment, as discussed herein, the footwear generator 30 may encode information that facilitates additive manufacture of the customized component.

As discussed herein, in one embodiment, the footwear generator 30 may be in communication with the virtual storefront 40. Examples of the virtual storefront 40 include a kiosk disposed in a storefront or a mobile application running on a mobile phone. The footwear generator 30 may receive from the virtual storefront 40 a consumer selection of footwear from a plurality of available options. The footwear generator 40 may obtain footwear model information relating to the selected footwear from the footwear database 32, and generate a virtual representation 105 of the selected footwear, possibly customized to the consumer's foot and/or preferences. The virtual representation 105 may be communicated to the virtual storefront 40 for display to the consumer.

In one embodiment, if the consumer ultimately decides to purchase the selected footwear, the footwear generator 30 may communicate encoded information to the manufacturing system 50 sufficient to manufacture the selected footwear in a manner customized for the consumer. For instance, the footwear generator 30 may communicate encoded information with respect to the custom last 150 to be used for manufacturing the selected footwear. The encoded information may also include data relevant to manufacturing the selected footwear, including, for example, the footwear model information, a footwear model identifier, and a customization feature or component, or a combination thereof.

### III. Virtual Storefront or Point-of-Sale System

The system 100 may include a virtual storefront 40 or point-of-sale system as discussed herein. The virtual storefront 40 may be configured similar to the custom last generator 20 and may include, for example, a processor, memory, an input interface and an output interface. For purposes of disclosure, the virtual storefront 40 is depicted separate from the custom last generator 20. Alternatively, the virtual storefront 40 and custom last generator 20 may share the same components, including processor 23, memory 21, input interface 25, and output interface 27. The virtual storefront 40 may be configured to display a plurality of available footwear options, and enable consumer selection of one or more of the available footwear options. Based on a consumer selection, the virtual storefront 40 may communicate with the footwear generator 30 to obtain a virtual representation 105 of the selected footwear customized based on at least one of the physical information and the user preference information. The virtual storefront 40 may be configured to display the virtual representation 105 of footwear, and may enable the consumer to select the virtual representation 105 for manufacture and sale.

For purposes of disclosure, the virtual storefront 40 is described in connection with a kiosk and a virtual reality headset capable of being worn by a user and facilitating browsing a selection of footwear options. However virtual storefront 04 is not so limited, and may be implemented in any digital environment, including, for example, on a mobile phone or tablet computer.

The virtual storefront 40 may include a point-of-sale display interface 44, a custom model display interface 46 and a user input/selection interface 42. The point-of-sale display interface 44 in the illustrated embodiment provides a virtual reality environment that can be seen and navigated by a consumer with a virtual reality headset (not shown). An example of the virtual reality environment or virtual storefront 200 is shown in the illustrated embodiment of FIG. 10. As can be seen, there are a plurality of available footwear options, some of which are designated 210. The consumer may be provided with a control interface 212 that may enable browsing of the virtual environment 200 and selection of one or more of the footwear options 210. At this stage, each of the footwear options 210 may be rendered based on a standard size foot or last (e.g., size 6 or size 9). Alternatively, each of the footwear options 210 in one embodiment may be rendered from the footwear generator 30 based on the custom last 150 generated by the custom last generator 20. In the illustrated embodiment, the footwear options 210 may be based on footwear information obtained from the footwear database 32.

The control interface 212 may form part of the user input/selection interface 42, and in one embodiment may be modeled after a standard videogame controller that offers first person point of view of control capabilities to navigate the virtual environment 200. The control interface 212, however, is not so limited and may be any type of control interface. The control interface 212 may enable a consumer to zoom in or out with respect to one or more footwear options 210 to achieve a closer look for browsing and possible selection.

After a consumer selects one or more of the footwear options 210, the virtual storefront 40 may communicate the one or more selected footwear options to the footwear generator 30. In one embodiment, the virtual storefront 40 and the footwear generator 30 may be incorporated into the same device, and the communication may be facilitated through memory of the device. Alternatively, the footwear generator 30 may be coupled to the virtual storefront 40 via a network interface, and the communication may be passed therethrough. As an example, the footwear generator 30 may be implemented in a server device separate from the device controlling the virtual storefront 40, thereby providing separate processing for the footwear generator 30 and the virtual storefront 40. The footwear generator 40 may process the one or more selected footwear options to render the visual footwear representation 105 based on the footwear model information for each selected footwear option, the custom last 150 produced by the custom last generator 20, and optionally one or more customization features, as discussed herein. The footwear generator 40 may communicate a digital version of the virtual representation 105 to a the custom model display interface 46 of the virtual storefront 40 to enable display of the virtual representation 105. The custom model display interface 46 may display the virtual representation 105 in the virtual environment 200 or in a separate display environment.

The custom model display interface 46 may enable the consumer to modify the virtual footwear representation 105, as discussed herein, to enable further customization. For instance, the custom model display interface 46 may provide color selectivity with respect to the virtual footwear representation 105.

If the consumer is satisfied with the virtual footwear representation 105, and ultimately selects the virtual footwear representation 105 for purchase, the virtual storefront 40 may initiate several steps including: a) invoicing the consumer and b) communicating directly or indirectly with the manufacturing system 50 to initiate manufacture of footwear substantially identical to the virtual footwear representation 105. In one embodiment, the virtual storefront 40 may communicate any of the information described herein to the consumer to aid in generation of future footwear orders without re-obtaining physical information via the physical data generator 10 and/or the user preference information via the user preference input system 12. Additionally, or alternatively, the virtual storefront 40 may store such information in a database collection associated with the consumer for future lookup and use for generating customized footwear.

In one embodiment, the virtual storefront 40 may provide information to the consumer, including an encoded document which enables the consumer to generate at least one of the custom last 150 and all or some components of the footwear using additive manufacturing. In this way, the consumer may manufacture all or some components without further involvement from the system 100. Such information may be provided with a license that enables only so many components to be manufactured according to the customized footwear order.

In general terms, the virtual storefront 40 may be configured to a) display to a consumer a plurality of images of footwear, b) receive input from the consumer to identify a selected footwear, c) generate a customized digital model pertaining to the selected footwear and based on at least one of the physical information and user preference information, d) communicating the customized digital models of the footwear and the custom last 150 to the manufacturing system 50.

In one embodiment, the virtual environment 200 may include at least one of an internet-based presentation of footwear, an in-store presentation of footwear, or traditional print advertising of available footwear. For example, one or more virtual footwear models or options can be presented to the consumer on a graphical user interface, optionally available in multiple views or rotatable as a three-dimensional virtual object. The virtual footwear can be hosted on a web server associated with the footwear database 32 in some embodiments.

Receiving input from the consumer to identify a selected footwear can be conducted in a variety of ways. The consumer's selection can originate from a device associated with the consumer, for example a computer, a laptop, a tablet, or a smartphone. Alternatively, the consumer's selection can include an in-person designation. The consumer's selection can include the type of footwear, the quantity, the color, the material properties, and any modifications available. The footwear generator 30 may generate a digital object model pertaining to the consumer's footwear selection.

### IV. Manufacturing System

The system 100 may include a manufacturing system 50 configured to manufacture footwear 110 according to encoded information and invoice information provided by at least one of the custom last generator 20, the footwear generator 30, and the virtual storefront 40. The encoded information may describe a digital object model or descriptive markup language that defines the custom last generated for the consumer. Optionally, the encoded information may include a digital object model for manufacturing one or more components of the footwear 110. The encoded information in one embodiment may also include at least one of a) a description of one or more customization features with respect to the footwear 110, such as color selection, and b) a description of the footwear 110 to be manufactured that is at least in part provided by the footwear database 32. In one embodiment, the invoice information may identify the footwear 110 to be manufactured in conjunction with the custom last 150.

The manufacturing system 50 in the illustrated embodiment includes at least one of the following: an assembly coordination system 58, an additive manufacturing system 52, a standard component manufacturing system 54, and an assembly system 56. One or more of these components may be fully automated. The assembly coordination system 58 may be configured similar to the custom last generator 20 such that the assembly coordination system 58 includes a processor, memory, an input interface, and an output interface. In the illustrated embodiment, the assembly coordination system 58 may receive the encoded information communicated via a network interface layer that utilizes the input and output interfaces. In order to manufacture the footwear ordered by the consumer, the assembly coordination system 58 may direct the additive manufacturing system 52 to physically generate the custom last based on the encoded information. Optionally, if the footwear to be manufactured includes one or more customized components, the assembly coordination system 58 may also direct the additive manufacturing system 52 to physically generate these components based on the encoded information. After a real-life form of the custom last 150, as well as any additional components, has been produced by the additive manufacturing system 52, the real-life form of the custom last 150 and any additional components may be transferred to the assembly system 56. In one embodiment, substantially all of the footwear components may be manufactured by the additive manufacturing system.

In the illustrated embodiment, the assembly coordination system 58 may communicate with a standard component manufacturing system 54 to generate a pick list of components for the footwear 110 to be manufactured. The standard component manufacturing system 54 may include an inventory of standard components, such as a plurality of uppers for a given footwear model and a given size. For instance, the standard component manufacturing system 54 may include an inventory of uppers in a size 6 (as well as other sizes) like the upper 120 depicted in the illustrated embodiment of FIG. 12, and an inventory of soles, midsoles and other footwear components to be joined with an upper to form the footwear. The footwear components identified on the pick list may be collected and transferred to an assembly system 56.

After the assembly coordination system 58 has directed the additive manufacturing system 52 and standard component manufacturing system 54 to produce and/or pull from inventory the real-life form of the custom last 150 and the footwear components related to the footwear 110 to be manufactured, the real-life form of the custom last 150 and the footwear components may be transferred to the assembly system 56. At this stage, assembly of the footwear 110 may proceed with fitting and assembly of the footwear components about the real-life form of the custom last 150. Optionally, assembly of the footwear 110 may be conducted in a a variety of ways, for example, assembling a customized sole and midsole based on the customizations identified by the consumer and custom assembly of the upper (e.g., based on the color selections of the consumer). The actual footwear 110 based on the virtual representation 105 may be provided to the consumer. A comparison between the virtual representation 105 and the real-life footwear 110 manufactured according to one embodiment of the present disclosure is depicted in the illustrated embodiment of FIG. 8.

The manufacturing system 50 may be located separate from devices that implement one or more of the custom last generator 20, footwear generator 30 and virtual storefront 40. For instance, the consumer may browse and ultimately purchase footwear via the virtual storefront 40 using a mobile device associated with the consumer or a kiosk at a store, and afterward, the footwear may be manufactured by the manufacturing system 50 in a remote location (perhaps another country) and shipped to the consumer. Alternatively, all or some portions of the manufacturing system 50 may be located in proximity to the consumer at the time of purchase, such as in the case of a kiosk ordering system disposed at a store. For instance, the store may include an on-site additive manufacturing system 52 configured to generate a real-life form of the custom last 120 and optionally one or more footwear components. The store may include an inventory of standard components, such as pre-manufactured uppers like the one in FIG. 12 and pre-manufactured soles which can be assembled about the customized last in the store. In this way, the consumer's selected footwear can be manufactured at or in close proximity to the point of sale.

The additive manufacturing system 52, often referred to as a three-dimensional (3D) printer, may be configured in a variety of ways. The additive manufacturing system 52 generally utilizes any technique that deposits or creates material in successive layers to form a three-dimensional object. In one embodiment, the additive manufacturing system 52 may perform a 3D print operation that begins with computer readable instructions on the additive manufacturing system 52 (which may include a processor, memory, input and output interfaces similar to the custom last generator 20), when executed, cause a 3D printer to form the custom last according to the associated data object model. Forming custom last generally includes printing successive layers of a thermoplastic, polymeric, metal or other material from an extrusion nozzle, where each layer of the material corresponds to a cross-sectional slice or other dimension of the custom last. The 3D printer performing this task can include any 3D printer having a build volume suitably sized for a custom last. Example 3D printers include, without limitation, the Replicator 2 available from MakerBot Industries of Brooklyn, New York, the Cube available from 3D Systems of Rock Hill, South Carolina, and the Solidoodle 2 available from Solidoodle LLC of Brooklyn, New York. The selected 3D printing material can include any material providing the desired material properties. The material properties can include strength, melting temperature, and coefficient of thermal expansion. Example materials include, without limitation, thermoplastic materials, such as acrylonitrile butadiene styrene (ABS) and polylactide (PLA), metals, such as alloys, composites and combinations of the foregoing. Other thermoplastic materials and non-thermoplastic materials can be used in other embodiments where desired. Optional post production techniques include sanding and acetone washes.

### V. Method of Manufacture

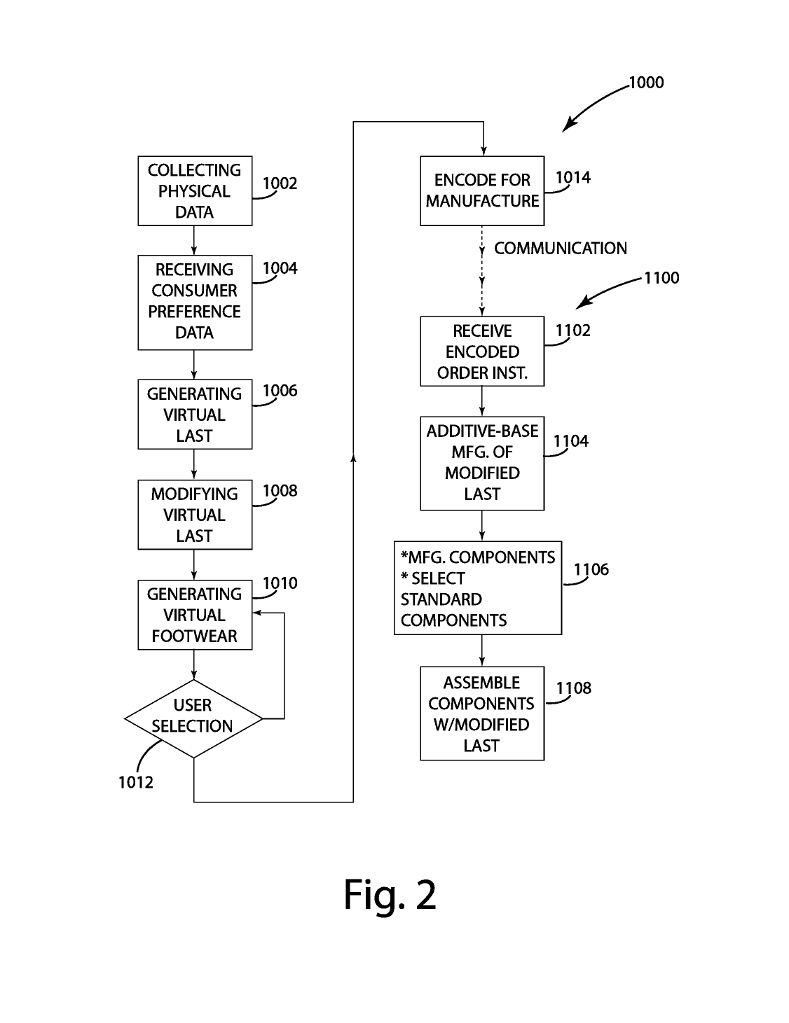

A method of generating a digital object model for a custom last and footwear is depicted in the illustrated embodiment of FIG. 2, and generally designated 1000. The method may be implemented in a system similar to the system 100 described herein, including one or more of a custom last generator 20, a footwear generator 30, and a virtual storefront 40. The method 1000 generally includes obtaining physical characteristic information with respect to a consumer's foot or feet. Step 1002. It should be noted that the custom footwear produced with a custom last according to one embodiment need not involve generation of two custom lasts, one for each foot, in cases where a consumer has only one foot. The physical characteristic information, as described herein, may include one or more objective measurements of the consumer's feet, including for example, length and girth. The objective measurements in one embodiment may include a surface profile of each foot.

Optionally, the method 1000 may involve obtaining consumer preference information or data with respect to the footwear. Step 1004. This type of data may include fit or feel information, such as the consumer's desire to have a looser or tighter fit in certain areas of the footwear. The data may also include the type of application and the degree of activity for that application. For instance, a runner that identifies themselves as a casual or low speed runner may find a more loose fitting shoe to be more comfortable, whereas a runner that identifies themselves as a performance runner or a high speed runner may find that tighter fitting shoes are more appropriate for their particular use pattern.

Based on at least one of the consumer preference information and the physical characteristic information, a virtual last may be generated. Step 1006. Generation of the virtual last may involve retrieving standard physical characteristic information for a standard foot that forms the basis for a standard last, and comparing this standard physical characteristic information against the consumer's physical characteristic information. Based on this comparison, deviations from the standard physical characteristic information can be identified. For instance, a consumer with a bunion on one foot may have a larger surface profile relative to a standard foot that forms the basis for footwear of a size generally available to the consumer. The deviation relating to the bunion may be mapped to a surface change in the standard last to yield a custom, virtual last. In one embodiment, the degree of change in the virtual last may correspond directly to the degree of deviation from the standard foot that forms the basis for the standard last. The user preference information may also be used as a basis for modifying the standard last to accommodate the consumer's preferences and to yield the custom, virtual last. Step 1008. At this stage, the custom, virtual last may be stored in memory as a digital object model, such as an encoded document, that describes the custom, virtual last.

With description information for a virtual last specific to the consumer stored in memory, footwear may be virtually generated to show the consumer what the footwear would look like if manufactured according to at least one of the consumer's physical characteristics and the consumer's preferences. Step 1010. More than one footwear may be generated and shown to the consumer as part of an iterative process through which the consumer can select a desired footwear for purchase. Step 1012. For instance, a virtual storefront may offer a plurality of footwear for purchase, depicting a visual representation of each footwear. The consumer may browse the virtual storefront and select footwear for customization. At this stage, the selected footwear may be generated based on the customized, virtual last. In one embodiment, the consumer may customize aspects of the selected footwear, such as color and the component configuration (e.g., a firmer or softer sole). If the consumer ultimately chooses to purchase the generated footwear, aspects of the generated footwear and/or the virtual, customized last may be encoded for communication to a manufacturing system. Steps 1012, 1014. Encoding the information may involve generation of a descriptive document that can be used as a basis for manufacturing the virtual version of the selected footwear and the virtual, custom last. For instance, the descriptive document may be an Extensible Markup Language file or XML file that can be communicated to a manufacturing system. The XML file may include field codes that identify aspects of the virtual last and/or the custom footwear in order to facilitate manufacture.

A method of manufacturing custom footwear according to one embodiment is shown in the illustrated embodiment of FIG. 2 and generally designated 1100. The method may involve receiving encoded information relating to at least one of a custom last and footwear to be manufactured. The encoded information, as discussed herein, may be in the form of an XML file or any other type of information descriptive of the custom last and footwear to be manufactured.

Step 1102. The encoded information may be communicated in a variety of ways, including via the internet or one or more network connections or shared memory, or any combination thereof.

With encoded information about the custom last, the custom last may be manufactured according to one or more manufacturing techniques, including additive manufacturing also known as 3D printing. Step 1104. Optionally, one or more footwear components may be manufactured based on the encoded information, including manufacturing via additive techniques. Step 1106.

In one embodiment, the method 1100 may include obtaining one or more standard components, such as an upper, sole and midsole, for manufacture of the footwear in conjunction with the custom last. Step 1106. One such standard upper is depicted in the illustrated embodiment of FIG. 12, and designated 120. The upper 120 may be a standard size based on the standard last used as a basis for the custom last. In manufacture, the upper 120 may be fitted to the custom last (instead of the standard last) to produce footwear specific to the consumer's foot and/or preferences. Step 1108.

Directional terms, such as “vertical,” “horizontal,” “top,” “bottom,” “upper,” “lower,” “inner,” “inwardly,” “outer” and “outwardly,” are used to assist in describing the invention based on the orientation of the embodiments shown in the illustrations. The use of directional terms should not be interpreted to limit the invention to any specific orientation(s).

The above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular. Any reference to claim elements as “at least one of X, Y and Z” is meant to include any one of X, Y or Z individually, and any combination of X, Y and Z, for example, X, Y, Z; X, Y; X, Z ; and Y, Z.

The embodiments of the invention in which an exclusive property or privilege is claimed are defined as follows:

1. A method of fitting a consumer for custom footwear comprising:
receiving consumer input at a consumer interface relating to consumer preference data;
scanning a foot of the consumer to collect physical characteristic data;
transferring the consumer preference data and the physical characteristic data to a controller;
obtaining, in the controller, a virtual last based on the physical characteristic data;
modifying the virtual last based on at least one of the consumer preference data and the physical characteristic data;
generating a virtual footwear model based on the modified virtual last, the virtual footwear model having an appearance representative of a real-life version of the virtual footwear; and
generating an encoded document based on the virtual footwear model and the modified virtual last, the encoded document providing a digital object model for manufacturing a custom last based on the modified virtual last and custom footwear substantially similar to the virtual footwear model.

2. The method of claim 1 further comprising manufacturing the custom footwear from the encoded document.

3. The method of claim 2 wherein said manufacturing the custom footwear further comprises operating an additive manufacturing device according to instructions based on the encoded document to generate the custom last.

4. The method of claim 1 wherein the consumer preference data pertains to at least one of application information and preference information about fit.

5. The method of claim 4 wherein the application information includes one of hiking, soccer, football, baseball, basketball and tennis.

6. The method of claim 4 wherein the preference information includes at least one of a more relaxed fit near medial and lateral sides of the foot, additional room in the toebox, and a wider opening for an ankle of the consumer.

7. The method of claim 1 wherein said scanning includes collecting physical characteristic data pertaining to at least one of contours of the foot and forces generated by the foot.

8. The method of claim 1 wherein said generating, in the controller, the virtual last includes generating a standard virtual last based on a standard foot that is similar but not identical to the foot of the consumer; and wherein said modifying includes modifying the standard virtual last based on the consumer preference data.

9. The method of claim 1 further comprising receiving consumer input at the consumer interface relating to a consumer desired footwear model; and
wherein said generating the virtual footwear model includes mapping the consumer desired footwear model on the modified virtual last to generate the virtual footwear model.

10. The method of claim 9 further comprising displaying, via the consumer interface, a plurality of footwear models.

11. The method of claim 10 wherein said displaying further comprising providing to the consumer a 3D virtual storefront with a plurality of footwear models to choose.

12. A system for forming and utilizing a framework for custom footwear, the system comprising:
a consumer interface to display a plurality of footwear models available for selection by a consumer;
a sensor configured to scan foot characteristics of the consumer to collect physical characteristic data relating to the foot;
a control system operably coupled to the consumer interface and the foot sensor, the control system programmed to receive from the sensor the physical characteristic data, the control system programmed to receive from the consumer interface consumer preference data and a consumer footwear selection relating to a consumer desired footwear from among the plurality of footwear models displayed on the consumer interface, the control system operable to generate a custom virtual last of the foot based on the physical characteristic data and the consumer preference data; and
wherein the control system is configured to generate a virtual footwear model based on the custom virtual last and the consumer desired footwear, and wherein the control system is configured to communicate information relating to the virtual footwear model to the consumer interface for display of the virtual footwear model to the consumer.

13. The system of claim 12 wherein the control system is configured to generate an encoded document based on the virtual footwear model, wherein the encoded document provides a framework for manufacturing the custom footwear substantially similar to the virtual footwear model, wherein the encoded document includes information based on the modified virtual last.

14. The system of claim 13 wherein the sensor is configured to scan at least one of the contours of the foot and the forces generated by the foot on a surface.

15. The system of claim 13 wherein the consumer preference data pertains to at least one of application information and preference information about fit.

16. The system of claim 15 wherein the application information includes one of hiking, soccer, football, baseball, basketball and tennis.

17. The system of claim 15 wherein the preference information includes at least one of a more relaxed fit near medial and lateral sides of the foot, additional room in the toebox, and a wider opening for an ankle of the consumer.

18. The system of claim 15 wherein the control system is configured to generate the virtual footwear model by mapping the consumer desired footwear on the modified virtual last.

19. The system of claim 13 wherein the control system further comprises an additive manufacturing controller programmed to direct an additive manufacturing device according to instructions based on the encoded document to produce a real-life form of the modified virtual last.

20. The system of claim 19 wherein the control system and the additive manufacturing device are disposed in a footwear storefront such that the modified virtual last and the custom footwear are manufactured at a point of purchase.

21. A method of manufacturing a custom last for a consumer, said method comprising:
obtaining, via a sensor, physical characteristic data with respect to a foot of the consumer;
determining a standard last for the foot based on the physical characteristic data;
obtaining from memory standard characteristic data for a standard foot that is the basis for the standard last;
comparing the standard characteristic data for the standard foot against the physical characteristic data for the foot of the consumer;
based on the comparison, modifying the standard last in order to yield a customized last for the foot of the consumer; and
three-dimensionally printing the customized last to facilitate manufacture of footwear that is based on the customized last and customized for the consumer.

22. The method of claim 21 comprising:
obtaining, via a user interface, consumer preference data; and
modifying the standard last based on the consumer preference data.

23. The method of claim 22 wherein the consumer preference data includes at least one of an application and a preferred fit.

24. The method of claim 21 comprising:
assembling an upper to a sole about the customized last to yield custom footwear for the foot of the consumer.
